(19) United States
(12) Patent Application Publication
(10) Pub. No.: US 2006/0289430 A1
(43) Pub. Date: Dec. 28, 2006

(54) Device and method for stabilizing a package

(76) Inventors: Alessandro Minarelli, Bazzano (IT); Alessandro Brizzi, Crespellano (IT); Stefano Salmi, Budrio (IT); Gilberto Spirito, Bologna (IT)

Correspondence Address: OSTROLENK, FABER, GERB & SOFFEN, 1180 Avenue of the Americas, New York, NY, 10036-8403, US

(21) Appl. No.: 11/475,686

(22) Filed: Jun. 27, 2006

(30) Foreign Application Priority Data
Jun. 27, 2005 (IT) BO2005A000421

(51) Int. Cl. F27B 9/06

(52) U.S. Cl. 219/388

(57) ABSTRACT

A device and method for stabilizing packets, each having two portions connected to each other by glue, the device having a conveyor for feeding the packets successively along a path; a number of heating members located along the path to heat and dry the glue to stabilize the packets; and a central control unit for selectively regulating the temperature of each heating member so that the heat transferred to the glue varies along the path.

The present invention relates to a device and method for stabilizing a package.

The present invention is especially advantageous for use in the manufacture of packets of cigarettes, to which the following description refers purely by way of example.

### BACKGROUND OF THE INVENTION

More specifically, the present invention relates to a device for stabilizing a folded package having two or more superimposed portions. The device comprises a conveyor assembly for feeding the package along a path from an input station to an output station; and an operating unit for exerting pressure on the superimposed portions and heating the package to connect the superimposed portions to one another.

Known devices of the type described above are seldom very versatile, and do not adapt easily to varying production requirements. The operating parameters (e.g. pressure and temperature), in particular, are normally extremely difficult to adjust to the materials being used and to the desired end product.

In this connection, it should be pointed out that the temperature and pressure at which the portions of the package are worked are normally maintained constant by the operating unit along the entire path, so that, particularly when working with specific adhesive materials, the portions of the package are not always connected satisfactorily.

### SUMMARY OF THE INVENTION

It is an object of the present invention to provide devices and methods designed to at least partly eliminate the aforementioned drawbacks.

According to the present invention, there are provided devices and methods as claimed in the attached Claims.

### BRIEF DESCRIPTION OF THE DRAWINGS

A non-limiting embodiment of the present invention will be described by way of example with reference to the accompanying drawings, in which:

FIG. 1 shows a schematic view, with parts removed for clarity, of a device in accordance with the present invention;

FIG. 2 shows a view in perspective of a packet that can be produced on the FIG. 1 device;

FIG. 3 shows a blank from which to produce the FIG. 2 packet;

FIG. 4 shows a larger-scale view in perspective of a detail of the FIG. 1 device;

FIGS. 5-7 show a schematic detail of the FIG. 1 device in different operating positions;

FIG. 8 shows a section of the FIG. 4 detail.

### DETAILED DESCRIPTION OF THE INVENTION

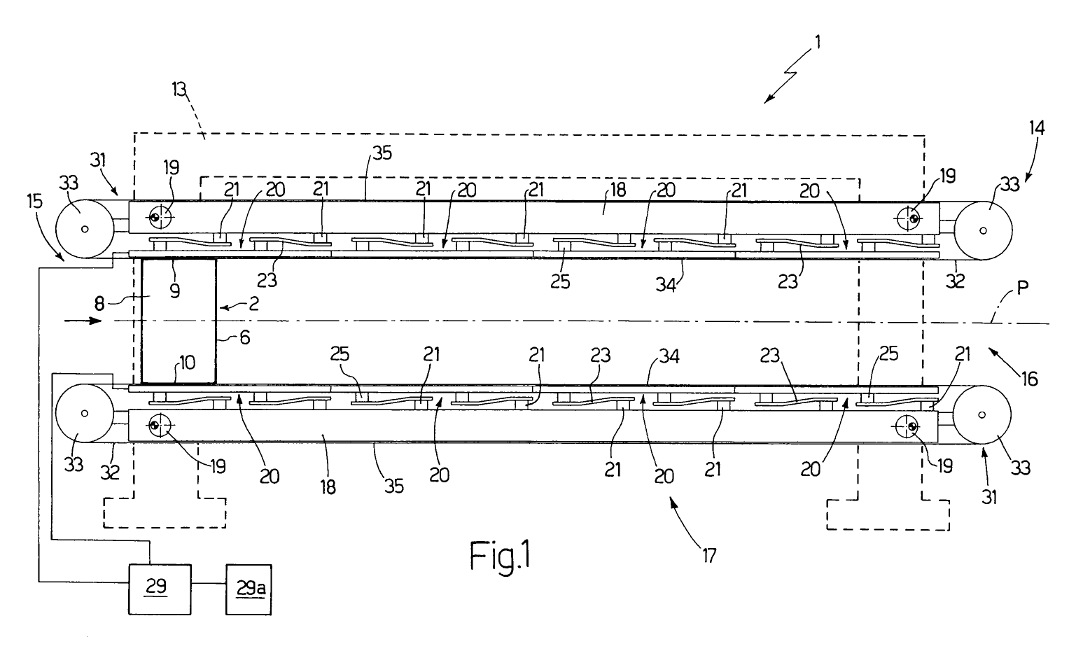

Number 1 in FIG. 1 indicates as a whole a device for stabilizing a packet 2 folded about a respective group of cigarettes (not shown).

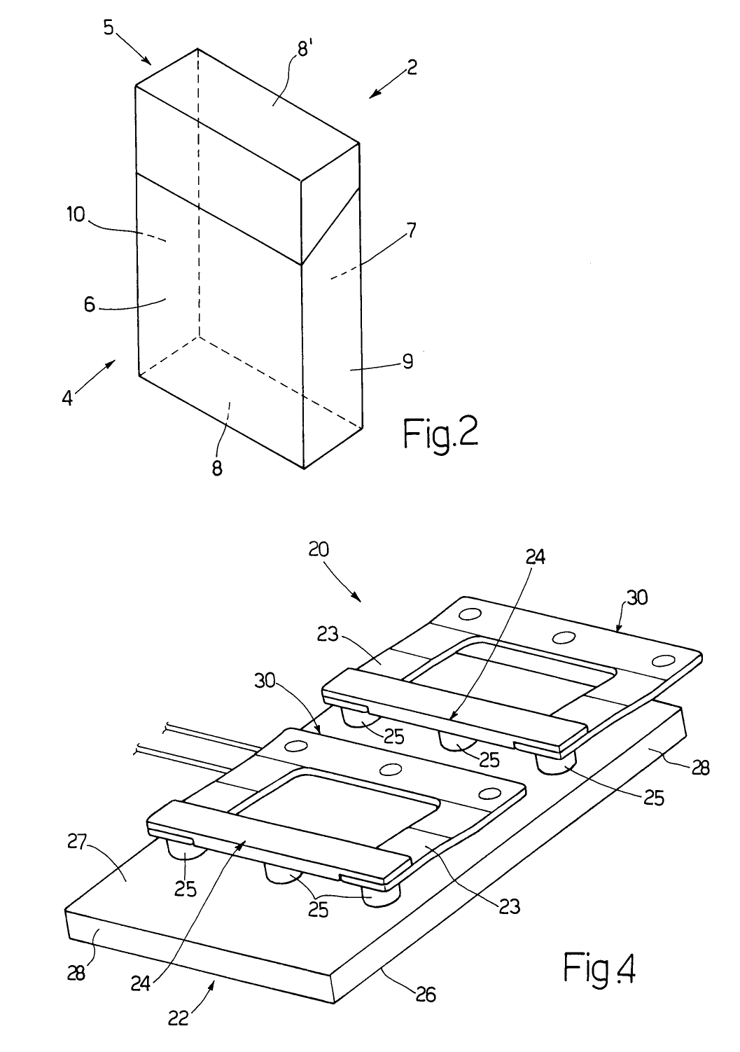

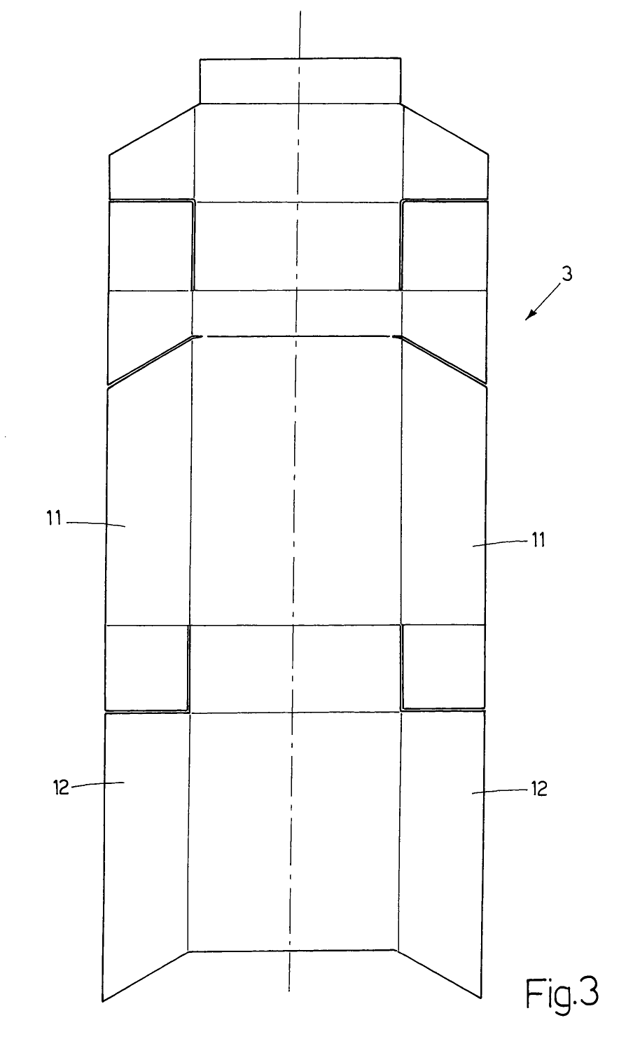

Packet 2 (FIG. 2) is a hinged-lid type, is substantially parallelepiped-shaped, is formed by folding a blank 3 (FIG. 3), and comprises a cup-shaped body 4, and a lid 5 hinged to cup-shaped body 4. Cup-shaped body 4 comprises a front wall 6; a rear wall 7; a bottom wall 8 substantially perpendicular to walls 6 and 7; and two substantially parallel lateral walls 9 and 10 perpendicular to walls 6, 7 and 8. Lid 5 comprises a top wall 8′ which, when lid 5 is in the closed position, is substantially parallel to wall 8 and defines the top of packet 2. Walls 9 and 10 are each formed by superimposing two respective portions 11 and 12 of blank 3; and a layer of heat-setting adhesive material (not shown) is interposed between portions 11 and 12.

Device 1 (FIG. 1) comprises a frame 13, on which are mounted a conveyor assembly 14 for feeding packet 2 from an input station 15 to an output station 16 along a path P; and an operating unit 17 for exerting pressure on superimposed portions 11 and 12, and heating packet 2 to stabilize (dry and set) the adhesive material (not shown) and connect portions 11 and 12 firmly to each other. In actual use, conveyor assembly 14 conveys packet 2 so that walls 8, 8′, 9 and 10 are maintained substantially parallel to path P, and walls 6 and 7 are maintained crosswise to path P.

Operating unit 17 comprises two supporting bars 18 located on opposite sides of path P, and each connected to frame 13 by two respective eccentric pins 19. Each supporting bar 18 extends alongside and substantially parallel to path P.

By adjusting eccentric pins 19 in a fairly straightforward manner, it is possible to adjust the position of supporting bars 18 with respect to each other, and the tilt of supporting bars 18 with respect to path P.

A number of heating members 20 are fitted integrally to each supporting bar 18 and arranged in succession along path P. More specifically, each supporting bar 18 has a number of connecting pins 21, to which heating members 20 are fitted removably.

Heating members 20 provide for generating and transferring heat to walls 9 and 10. With particular reference to FIGS. 1 and 4, each heating member 20 comprises a respective body 22; and at least one respective leaf spring 23 connected at one end 24 to body 22 by means of three pins 25 (in the depicted embodiment leaf springs 23 are two).

Body 22 (FIG. 8) comprises an outer metal plate 26 substantially parallel to path P; a supporting layer 27 to which pins 25 are fitted; and an intermediate layer 28 interposed between plate 26 and support 27 and made of electrically insulating material in which an electric resistor (not shown) is embedded. The electric resistor (not shown) is connected to a control unit 29 which regulates the heat transferred by each heating member 20 to packet 2, by acting on the current supply to the electric resistor. More specifically, each heating member 20 has a temperature sensor (not shown) connected to control unit 29; and control unit 29 regulates current supply to each heating member 20 as a function of the temperature detected by the respective temperature sensor (not shown), and of a predetermined temperature at which heating member 20 is to be maintained. The predetermined temperature at which each heating member 20 is to be maintained is determined on the basis of data entered into control unit 29 by an operator by means of an interface 29a (HMI; e.g. a keyboard and screen).

The temperature of each heating member 20 is adjustable individually and independently of the temperature of the other heating members 20, so that the heat transferred by operating unit 17 to portions 11 and 12 varies along path P. In other words, in actual use, packet 2 is fed along path P through areas of different temperatures. The temperature parameters can therefore be adjusted extremely flexibly as a function of the materials used and of the desired end product, to obtain a more stable connection of portions 11 and 12.

Generally speaking, the possibility of adjusting the temperature of each heating member 20 separately provides for extremely flexible production parameter adjustments. In particular, only some of heating members 20 may be activated to reduce electricity consumption; and a faulty heating member 20 may be deactivated, and the temperature of the other heating members 20 increased to maintain a substantially constant heat supply to the adhesive material (not shown) between portions 11 and 12.

Another important point to note is that, in the event device 1 is stopped and started up again, the temperatures of heating members 20 can be adjusted so that the packet 2 located along path P at the time of the stoppage can still be correctly stabilized.

At the end 30 opposite end 24, each leaf spring 23 is fitted to connecting pins 21, and acts as a shock absorber by allowing respective body 22, and therefore relative plate 26, to move, in cushioned manner, parallel to itself and substantially perpendicularly to path P. Leaf spring 23 provides for compensating any minor variations in the size of packet 2, and so reducing the risk of damage to packet 2.

If necessary, e.g. in the event of a malfunction, heating member 20 can be changed quickly and easily. In this connection, it is important to note that each heating member 20 can be changed and/or repaired individually, thus reducing maintenance cost.

Conveyor assembly 14 comprises two conveyors 31, each connected integrally to a respective supporting bar 18. More specifically, each conveyor 31 comprises a respective conveyor belt 32 running about two respective pulleys 33 and having a respective work branch 34, and a respective return branch 35. Pulleys 33 of each conveyor 11 are fitted in rotary manner to relative supporting bar 18, so that work branch 34 is interposed between heating members 20 and path P. Work branch 34 and return branch 35 are substantially parallel to path P.

Normally, the distance between work branches 34 of conveyors 31 substantially equals the distance between walls 9 and 10, so that packet 2, in use, is conveyed along path P with each wall 9, 10 contacting a relative work branch 34.

Consequently, in actual use, portions 11 and 12 are pressed against one another, and, at the same time, the heat generated by the resistors (not shown) of heating members 20 travels through respective plates 26 and relative belts 32 to the adhesive material (not shown) between portions 11 and 12, thus drying the adhesive material and connecting portions 11 and 12 firmly to one another.

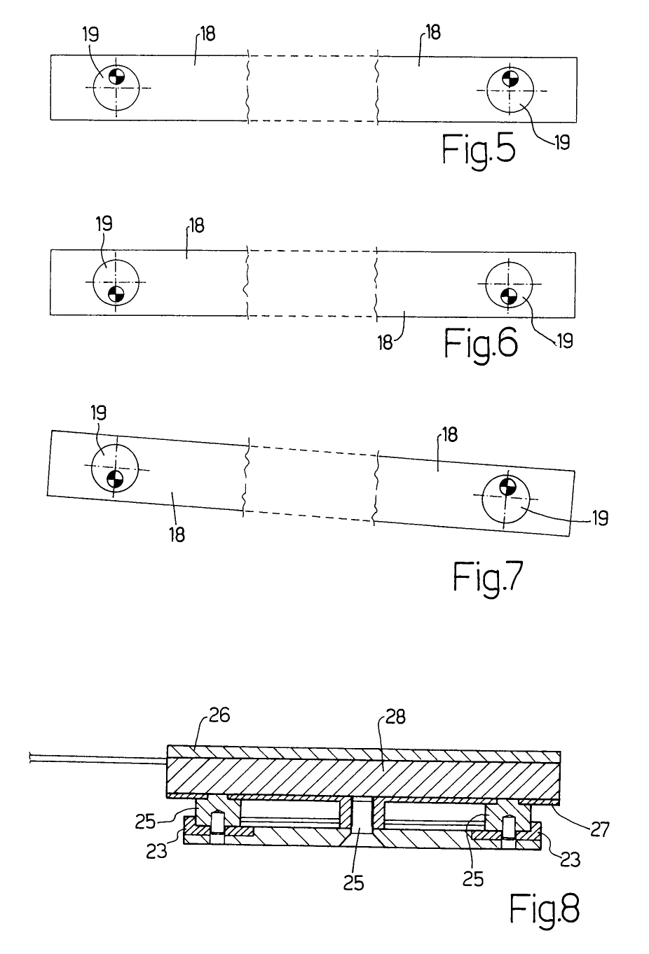

In actual use, to change the size of packet 2 or adjust the pressure exerted on walls 9 and 10, the distance between work branches 34 can be adjusted easily using eccentric pins 19. Purely by way of example, FIGS. 5 and 6 show various operating positions of one of supporting bars 18 shown in the mid-height position in FIG. 1. More specifically, supporting bar 18 is shown in the “lowered” position in FIG. 5 and in the “raised” position in FIG. 6.

Another important point to note is that, being provided with two eccentric pins 19 adjustable substantially independently of each other, each supporting bar 18 can be tilted with respect to path P (FIG. 7) to vary the pressure exerted on superimposed portions 11 and 12 along path P. In other words, the pressure exerted on portions 11 and 12 varies (a pressure gradient is formed) as packet 2 travels along path P. Eccentric pins 19 are advantageously adjusted so that the pressure exerted on portions 11 and 12 increases along path P. It should be noted that the position of work branches 34 with respect to each other is adjusted integrally with the position of supporting bars 18.

In actual use, as opposed to packets 2 being fed singly along path P, a number of substantially similar packets 2 are normally fed seamlessly (i.e. with walls 6 and 7 contacting) from input station 15 to output station 16, so that a given pressure is also exerted on walls 6 and 7 to reduce the risk of deformation of packet 2.

In this connection, it should be pointed out that device 1 comprises a sensor (not shown) for detecting the presence of packets 2 at input station 15.

In actual use, when a gap is detected between successive packets 2 at input station 15, conveyor assembly 14 is stopped temporarily to close the gap in the succession of packets 2 fed along path P.

In an embodiment not shown, device 1 comprises two substantially identical conveyor assemblies 14 for feeding packets 2 along two substantially parallel paths P.

In a further embodiment not shown, device 1 comprises supporting members (not shown) for stabilizing and preventing deformation of walls 8 and 8′ as packet 2 travels along path P, and which may, for example, comprise two substantially fixed slide surfaces (not shown) on opposite sides of belts 32.

In actual use, walls 8 and 8′ slide along said slide surfaces, which support and prevent deformation of walls 8 and 8′, and which are particularly advantageous along portions of path P where greater pressure is exerted on walls 9 and 10 (i.e. where said pressure varies along path P).

Though the above description and accompanying drawings refer to stabilizing a conventional hinged-lid packet 2 of cigarettes, the teachings of the present invention may obviously also be applied to any type of packet, such as a “soft” packet of cigarettes.

Moreover, in alternative embodiments not shown, some of the longitudinal and/or transverse edges of packet 2 may be non-square rounded or bevelled edges. For example, the longitudinal edges may be non-square rounded or bevelled edges, or (like the packet of cigarettes described in Patent Application EP-A1-0764595), the major transverse edges may be non-square rounded or bevelled edges. Alternatively, some of the longitudinal and transverse edges may be non-square edges, so as to have both non-square rounded or bevelled longitudinal and transverse edges.

In an alternative embodiment not shown, packet 2 may be as described in Patent Application EP-A1-1066206; in which case, each wall 6, 7 is outwardly convex, and comprises a flat central portion and two curved creased lateral bands.

The teachings of the present invention may obviously also be applied to cartons of cigarettes, and to packages of other than cigarettes, such as food products, confectionary, or toiletries.

As will be clear from the above description, device 1 has important advantages as compared with the known state of the art, by enabling, among other things, extremely fast, easy adjustment of operating parameters (in particular, pressure and temperature).

1) A device for stabilizing a package folded about a respective article and having at least two superimposed portions (11, 12), the device (1) comprising a conveyor assembly (14) for feeding the package (2) from an input station (15) to an output station (16) along a path (P); and an operating unit (17) for exerting pressure on the portions (11, 12) and heating the package (2), as the package (2) travels, in use, along the path (P), to connect the portions (11, 12) to each other; the device (1) being characterized in that the operating unit (17) comprises a first heating member (20) located along said path (P), and at least one second heating member (20) located downstream from the first heating member (20) along the path (P); the first and second heating member (20) being designed to heat said portions (11, 12).

2) A device as claimed in claim 1, wherein the first and second heating member (20) are substantially fixed along the path (P).

3) A device as claimed in claim 1, wherein the first and second heating member (20) are designed to heat up so as to heat said portions (11, 12).

4) A device as claimed in claim 1, wherein the operating unit (17) comprises a control unit (29) for independently regulating the heat supplied by the first heating member (20) and the heat supplied by the second heating member (20).

5) A device as claimed in claim 1, wherein the first and second heating member (20) are removable individually from the operating unit (17).

6) A device as claimed in claim 1, wherein the first and second heating member (20) each comprise a respective heating plate (26) and respective shock-absorbing means (23); the shock-absorbing means (23) allowing the relative heating plate (26) to move crosswise to the path (P) in cushioned manner.

7) A device as claimed in claim 1, wherein the operating unit (17) comprises adjusting means (19) for adjusting the pressure exerted, in use, on the portions (11, 12) of the package (2).

8) A device as claimed in claim 7, wherein the adjusting means (19) adjust the pressure exerted, in use, on the portions (11, 12) of the package (2), so that the pressure varies along the path (P).

9) A device as claimed in claim 7, wherein said adjusting means (19) comprise at least one eccentric pin (19).

10) A device as claimed in claim 9, wherein the adjusting means (19) comprise at least two eccentric pins (19).

11) A device as claimed in claim 1, wherein the operating unit (17) comprises at least one first supporting member (18) extending alongside the path and to which the first and second heating member (20) are fitted integrally.

12) A device as claimed in claim 11, wherein the operating unit (17) comprises first adjusting means (19) for adjusting the position of the first supporting member (18).

13) A device as claimed in claim 12, wherein the first adjusting means (19) adjust the tilt of the first supporting member (18) with respect to the path (P).

14) A device as claimed in claim 12, wherein said conveyor assembly (14) comprises a first conveyor (31) in turn comprising a respective conveyor belt (32) having a first work branch (34) and a first return branch (35); the first work branch (34) extending alongside the path (P); and the first adjusting means (19) adjusting the position of the first work branch (34) integrally with the position of the first supporting member (18).

15) A device as claimed in claim 14, wherein the first conveyor (31) is connected integrally to the first supporting member (18).

16) A device as claimed in claim 14, wherein the first and second heating member (20) are located on the opposite side of the first work branch (34) to the path (P).

17) A device as claimed in claim 11, wherein the operating unit (17) comprises at least one second supporting member (18) fitted with further heating members (20); the first and second supporting member (18) being located on opposite sides of the path (P).

18) A device as claimed in claim 17, wherein the operating unit (17) comprises second adjusting means (19) for adjusting the position of the second supporting member (18).

19) A device as claimed in claim 18, wherein the second adjusting means (19) adjust the tilt of the second supporting member (18) with respect to the path (P).

20) A device as claimed in claim 18, wherein said conveyor assembly (14) comprises a second conveyor (31) in turn comprising a respective conveyor belt (32) having a second work branch (34) and a second return branch (35); the second work branch (34) extending alongside the path (P); and the second adjusting means (19) adjusting the position of the second work branch (34) integrally with the position of the second supporting member (18).

21) A device as claimed in claim 20, wherein the second conveyor (31) is connected integrally to the second supporting member (18).

22) A device as claimed in claim 20, wherein the path (P) and the further heating members (20) are located on opposite sides of the second work branch (34).

23) A method of stabilizing a package folded about a respective article and having at least two superimposed portions (11, 12), the method comprising the steps of conveying the package (2) from an input station (15) to an output station (16) along a path (P); exerting pressure on the portions (11, 12); and heating the package (2) to connect the portions (11, 12) to each other; the steps of exerting pressure and heating being substantially simultaneous with the step of conveying the package (2); and the method being characterized in that the heat supplied to the portions (11, 12) is varied as the package (2) is conveyed along the path (P).

24) A method as claimed in claim 23, and comprising a first adjusting step to adjust the heat supplied to the portions (11, 12) along the path (P).

25) A method as claimed in claim 23, and comprising a second adjusting step to adjust the pressure exerted on the portions (11, 12) along the path (P).

26) A method as claimed in claim 23, wherein the pressure exerted on the portions (11, 12) of the package (2) is varied as the package (2) is conveyed along the path (P).

27) A device for stabilizing a package folded about a respective article and having at least two superimposed portions (11, 12), the device (1) comprising a conveyor assembly (14) for feeding the package (2) from an input station (15) to an output station (16) along a path (P); and an operating unit (17) for exerting pressure on the portions (11, 12) and heating the package (2), as the package (2) travels, in use, along the path (P), to connect the portions (11, 12) to each other; the device (1) being characterized by comprising adjusting means (19) for adjusting the pressure exerted, in use, on the portions (11, 12) of the package (2).

28) A device as claimed in claim 27, wherein the adjusting means (19) adjust the pressure exerted, in use, on the portions (11, 12) of the package (2), so that the pressure varies along the path (P).

29) A device as claimed in claim 27, wherein said adjusting means (19) comprise at least one eccentric pin (19).

30) A device as claimed in claim 29, wherein the adjusting means (19) comprise at least two eccentric pins (19).

31) A method of stabilizing a package folded about a respective article and having at least two superimposed portions (11, 12), the method comprising the steps of conveying the package (2) from an input station (15) to an output station (16) along a path (P); exerting pressure on the portions (11, 12); and heating the package (2) to connect the portions (11, 12) to each other; the steps of exerting pressure and heating being substantially simultaneous with the step of conveying the package (2); and the method being characterized in that the pressure exerted on the portions (11, 12) of the package (2) is varied as the package (2) is conveyed along the path (P).

32) A method as claimed in claim 31, and comprising an adjusting step to adjust the pressure exerted on the portions (11, 12) along the path (P).
